(19) United States
(12) Patent Application Publication
(10) Pub. No.: US 2007/0125506 A1
(43) Pub. Date: Jun. 7, 2007

(54) SHADE SYSTEM WITH BRAKED SLIDER

(75) Inventors: Manuel EISELT, Rosenheim (DE); Norbert ELBS, Muenchen (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 11/561,014

(22) Filed: Nov. 17, 2006

Related U.S. Application Data
(63) Continuation-in-part of application No. PCT/EP05/05061, filed on May 11, 2005.

(30) Foreign Application Priority Data
May 17, 2004 (DE) 10 2004 024 382.4

(51) Int. Cl. B60J 1/20

(52) U.S. Cl. 160/370.22

(57) ABSTRACT

A vehicle shade system with a shade (13) which is extended against the reset force (16a) of a take-up roller (13a) and at least one pull (31), the pull containing a handle (18) for actuating the shade and laterally at least one slider (10) each which is movably supported in a guide rail (22) which runs parallel to the closing direction (12) of the shade and has at least one braking surface (15). The slider (10) is made such that when the handle (18) is released, by the reset force of the take-up roller (13a) the braking surface (15) is shifted toward the guide rail (22), by which it brakes with at least one opposing surface of the guide rail.

### CROSS-REFERENCE TO RELATED APPLICATION

This application is a Continuation-in-Part of co-pending International Application No. PCT/EP2005/005061.

### BACKGROUND OF THE INVENTION

1. Field of the Invention

This invention relates to a shade system with braked slider having a take-up roller, a shade which is extendable against a reset force of the take-up roller, a guide rail which runs parallel to a closing direction of the shade, and at least one pull, the pull having a handle for actuating the shade and at least one slider at each of opposite lateral sides which is movably supported in the guide rail and which has at least one braking surface.

2. Description of Related Art

Existing manual shades with the positions completely opened and completely closed, such as for example cargo space covers for station wagons, often contain a pretensioned take-up roller which allows a reset force to act on the extended shade. This results in that when the extended shade in the closed position is released the subsequent take-up of the shade is carried out automatically by the pretensioned take-up roller. When such a pretensioned shade however does not have a braking means, after release the shade can snap back from the closed position and in doing so can damage attachments or can even be damaged itself, if special safety measures (which in turn means additional costs, installation space and weight) are not considered. External brakes, such has for example silicone brakes, are certainly conceivable, but they work in both directions, by which the force which must be used to pull out the shade is increased. Other systems for braking a pretensioned shade can also be designed to fix the shade in the position in which an operator releases the corresponding handle on the shade.

German patent Application DE 102 45 929 A1 and corresponding U.S. Patent Application Publication No. 2004/0068839 describe an assembly formed of at least one guide rail and a carriage which can preferably be used in a sunshade in a motor vehicle. The assembly contains a carriage which has a brake element which can interact with the braking surface of a guide rail, the carriage having at least one spring which acts on the carriage such that the brake element is pressed against the braking surface. This ensures that the carriage remains in the respective position in the guide rail. The carriage furthermore has a tipping edge, and for example by pulling on the handle of the shade the carriage is pivoted around the tipping edge against the action of the spring, by which the brake element is released from the braking surface and the carriage can be displaced within the guide rail. As soon as the operator ceases to move the carriage in the guide rail, it is pressed back again into its initial position by the spring and locked.

German Patent Application DE 102 48 958 A1 and corresponding U.S. Pat. No. 6,892,786 also disclose an assembly which contains at least one guide rail and a carriage especially for a sunshade in a motor vehicle. In this case the carriage in turn also has at least one brake element which can engage a brake groove of the guide rail to lock the carriage in the guide rail when the operator releases the shade. In this connection the carriage has an axis of rotation and a support element which is spaced apart from the axis of rotation and which presses the brake element into the brake groove as a result of its spring action. As in German patent Application DE 102 45 929 A1 and corresponding U.S. Patent Application Publication No. 2004/0068839, thus a shade is also formed here in which by actuation of the handle by the operator and the resulting release of the brake element from the guide rail, displacement of the shade is enabled, and on the other hand, when the handle is released the shade is fixed immediately in the respective position.

### SUMMARY OF THE INVENTION

A primary object of this invention is to devise a shade system of the initially mentioned type in which snapping back of the shade into the opened position is prevented when a pretensioned, unwound shade in the closed position is released. It is furthermore the object of this invention to devise a corresponding approach which can be economically produced and offers great ease of operation to the operator.

In a vehicle shade system with a shade which is extended against the reset force of a take-up roller, at least one pull, the pull containing a handle for actuating the shade, and laterally at least one slider each which is movably supported in a guide rail which runs parallel to the closing direction of the shade and to which at least one braking surface is assigned, this object is achieved in accordance with the invention in that the slider is made such that when the handle is released, by the reset force of the take-up roller the braking surfaces of the slider are shifted toward the guide rail and brake with at least one opposing surface of the guide rail. Since in this approach in accordance with the invention the reset force of the shade itself, i.e. the take-up roller, shifts the braking surface, the use of additional spring elements for example is eliminated. An operator of the shade can thus unroll the shade by pulling on the handle and as soon as the shade has been completely unrolled, he can fix it in a suitable manner. To take up the shade, the shade is released and then the operator can release the handle. By the braking action of the slider with the guide rail the shade is then taken up braked, by which snapping back of the pretensioned shade and the resulting problems described above are prevented.

In the first embodiment of the invention, the slider has an axis of rotation perpendicular to the closing direction of the shade around which the slider is tilted by the reset force of the shade, by which, when the shade is released to be taken up, the braking surface of the slider is pressed against the opposing surface of the guide rail in order to brake with it. The braking force produced by the braking surface can be established by the corresponding configuration of the individual components of the shade system, in particular in this embodiment the braking force can be set by the choice of the friction coefficients of the braking surface and of the lever ratio on the slider. In an especially preferred embodiment of this invention, the axis of rotation of the slider is parallel to the take-up roller onto which the shade is taken up. Furthermore, the slider can have at least two braking surfaces which are located diametrically to the axis of rotation of the slider and which when the slider is tilted each brake with two opposing surface of the guide rail.

While the shade system can be made such that the braking surface is formed at least in part by the slide surface of the slider guided in the guide rail, in alternative embodiments the guide rail can have a guideway in which the slider is movably supported, the opposing surface of the guide rail with which the braking surface brakes being located outside the guideway. Since in the latter case the braking surface assigned to the slider and the sliding surface of the slider run in different tracks of the guide rail, in the slide channel friction-reducing means, for example grease, can be used without in this way the braking action of the braking surface being adversely affected.

In one alternative, preferred embodiment of the invention the slider has a holder and a slide cap with at least one braking surface, the holder being connected to the shade and the slide cap being movably supported parallel to the withdrawal direction of the shade. The holder and the slide cap are then, when the shade is released to unwind, displaced against one another by the reset force of the shade transversely to the displacement direction of the shade along at least one common slide surface, by which in turn the braking surface is pressed against the opposing surface of the guide rail and brakes with it.

In one preferred embodiment of this alternative, the common slide surface is formed from at least one sloped flank of the holder and at least one sloped flank of the slide cap and is comprised essentially of flat individual surfaces which with the displacement direction of the shade forms an angle between 10° and 80°, even better, between 30° and 60°. Thus, the relative motion of the holder against the slide cap parallel to the withdrawal direction of the shade is converted partially into motion transversely to the withdrawal direction. The sloped flanks of the holder are aligned preferably in the direction of the take-up roller, the sloped flanks of the slide cap conversely in the withdrawal direction of the shade.

In another preferred embodiment of this alternative, the holder and the slide cap along the displacement direction of the shade have a sawtooth-like surface, the teeth of the holder and slide cap each being formed by essentially vertical flanks and by the sloped flanks. Thus, the above described structure with sloped surfaces is periodically repeated.

In the embodiments with holder and slide cap, the holder can be inserted into the slide cap, the holder elastically deforming the slide cap to the outside at an angle to the displacement direction when the two are displaced against one another, to the extent that the braking surface of the slider brakes with the guide rail. Depending on the configuration of the guide rail, this can take place horizontally, vertically, and at an angle or also radially.

The braking surfaces of the slider can be integrated into the slider or can be formed as separately attached elements with a high friction coefficient.

The slider can generally have several slide surfaces which brake with at least two opposing surfaces of the guide rail which are located on opposing sides of the slider. For a u-shaped guide rail, the slider can thus be within the two legs and can brake with both.

Preferably, the reset force of the shade is always greater than the braking action of the slider altogether. Thus the shade during take-up is braked, but not blocked. But conversely blocking can also be accomplished by the brake action being increased. The latter can be preferred in shades for protection against the sun when the shade is also to be fixed in intermediate positions.

The shade system in the preferred embodiments is designed such that by pulling on the handle in the closing direction this tension force acts opposite the reset force of the shade and thus at least one braking surface is shifted away from the guide rail, by which the braking action is reduced. Thus the force expended for unrolling the shade is reduced.

In the embodiments in which the slider is tilted, when the slider is pulled by an operator the handle can cause a torque on the slider which is opposite the torque by the reset force of the shade. In the embodiments with a slide cap and holder, the handle is preferably connected to the slide cap in order to again separate the two elements from one another at the location of the common slide surface.

In another embodiment of the invention, the slider consists of a slide body which is connected to the shade, and of a separate brake body which is located between the slide body and shade. The slide body in this connection has a wedge-shaped extension which points in the direction of the brake body, and the brake body has a notch which the extension hits when the shade is rolled up, as soon as the operator releases the shade to roll up. The brake body is then spread apart by the wedge-shaped extension of the slide body and brakes with the guide rail. The slide body and brake body can be connected to one another via a driver such that the brake body is allowed to move as far as the stop of the driver parallel to the direction of motion of the slider away from the slide body.

In all versions the actuation of the handle for pulling out the shade leads to the braking force of the slider being reduced and the shade being released.

Preferred embodiments of this invention are explained in detail below with reference to the drawings.

### BRIEF DESCRIPTION OF THE DRAWINGS

FIG. 1 is a side view of a shade system in accordance with the invention for a motor vehicle, in which a slider moves to the right and the shade assigned to it is taken up, the carriage being tilted in the guide rail;

FIG. 2 shows the slider from FIG. 1, but in a situation in which the shade is unwound by pulling on the handle;

FIG. 3 shows an alternative version of the invention with a slider which is comprised of a holder and a slide cap, the shade being unrolled to the left in the figure;

FIG. 4 shows the slider in accordance with the invention from FIG. 3, which is pointed to the right here in the phase of take-up of the shade, by which the slider in turn brakes with the guide rail;

FIG. 5 is a perspective view of the slider in accordance with the invention from FIGS. 3 & 4;

FIGS. 6 & 7 show another alternative version of the invention in which a slider is comprised of a slide body and a brake body and braking action arises by the brake body being spread apart by the slide body; and

FIGS. 8 to 10 are, respectively, perspective, lengthwise and cross-sectional views of another alternative embodiment of the invention.

### DETAILED DESCRIPTION OF THE INVENTION

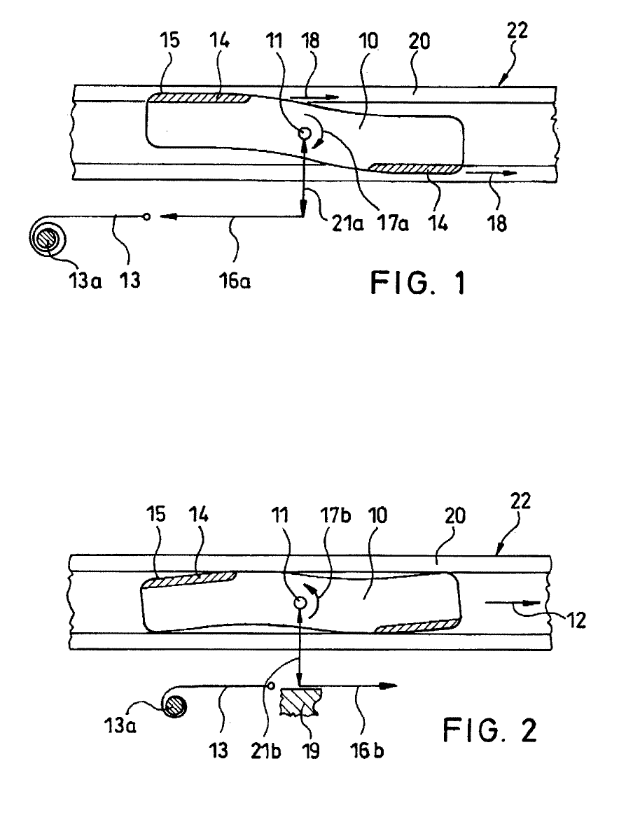

FIG. 1 shows a slider 10 in accordance with the invention which is guided by means of a guide rail 22 which has a guide groove 20 which fixes the slider transversely to the displacement direction of the shade 13. The slider 10 and the shade 13 are connected by means of a pull which is not shown here and the shade is wound and unwound from a pretensioned take-up roller 13a. The slider 10 has two braking surfaces 15 with which it brakes with the guide rail 22. These braking surfaces can be made integrally on the slider 10, or as is shown in FIG. 1, can be formed by separate brake elements 14 which intensify the brake action by a high coefficient of friction. The slider 10, itself, can be, for example, a plastic part which is produced by means of an injection molding process, and the brake elements 14 can be for example injected on the slider. The braking action is achieved by a torque 17a acting on the slider 10 around the axis of rotation 11 by a reset force 16a of the shade 13 to the left via a lever arm 21a. Since in FIG. 1 only the torque 17a of the shade 13 is acting and not for example an additional torque or an additional force by an operator, the slider 10 is thus tilted clockwise in the plane of the figure and the brake elements 14 and braking surfaces 15 are pressed against the opposing surfaces of the guide rail 22 (FIG. 1 is a schematic—in reality the brake elements 14 are not pressed into the guide rail 22, but are elastically compressed). The slider 10 is shaped in this connection (roughly S-shaped) such that this tilting results in a larger resting surface of the slider on the guide rail 22. Thus braking forces 18 are formed which counteract the reset force 16a of the shade 13 and thus are opposite the take-up direction of the shade. The braking force of the slider can be established for example via the length of the lever arm 21A of the shade 13, the reset force 16a of the shade or the coefficient of friction of the braking surfaces 15, such that when this shade is released it is taken up in a damped, controlled motion, and the slider 10 thus moved to the left in the figure. Alternatively the braking action can also be higher than the reset force, by which the shade 13 is blocked in the guide rail 22 when released.

FIG. 2 shows the slider 10 from FIG. 1 turned into the position as is reached when the shade is pulled out. The slider 10 is connected via one lever arm 21 b to the handle 19 by means of which the operator 13 can unroll the shade in order for example to cover the cargo space of a station wagon. The unrolling direction of the shade 13 and thus the direction of motion of the slider 10 proceed in this connection to the right along the closing direction 12 of the shade. As is shown in FIG. 2, the tension force 16 (the arrow is intended to indicate the direction here) on the handle 19 applies a torque 17b to the slider 10, by which it is swung in the direction counterclockwise around its axis of rotation 11. This rotation releases the brake element 14 with the braking surfaces 15 from the guide rail 22, and thus, the brake elements no longer brake with the guide rail. Rather the slider 10 with a reduced area with lower coefficients of friction comes into contact with the guide rail 22, for which reason the braking force is low compared to the tension force 16b on the handle 19. As a result, the operator can thus move the slider 10 together with the shade 13 attached to it easily and comfortably in the closing direction 12.

At this point, the shade 13 can for example be hooked into a holding device by means of the aforementioned pull when the completely extended shade reaches the end position. As soon as the shade 13 is unhooked again from this holding device and the operator in the position as shown in FIG. 2 releases the handle 19, the reset force 16a of the shade pivots the slider 10 into the position as shown in FIG. 1, by which the brake elements 14 with their braking surfaces 15 brake with the guide rail 22 and the shade is taken up braked.

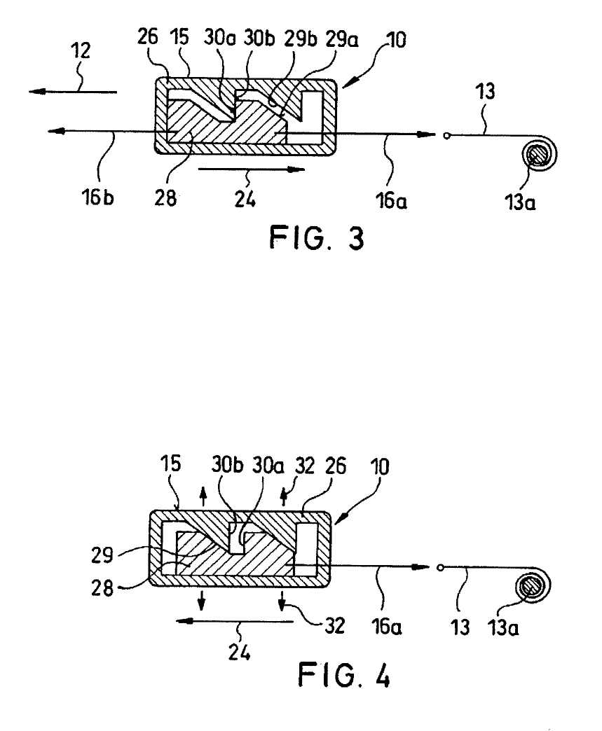

FIG. 3 shows an alternative embodiment of the invention in which a slider 10 is made in two parts and has a holder 28 and a slide cap 26. The holder 28 which is connected to the shade 13 via a pull is thus supported to be able to move relative to the slide cap 26 and is inserted into it. The holder 28 and slide cap 26 in this view from the side at the slider 10 have one sawtooth-like region each, the “teeth” being formed by sloped flanks 29a and 29b and vertical surfaces 30a and 30b. FIG. 3 shows the situation when an operator unrolls the shade 13 in the closing direction 12 from the take-up roller 13a to the left by his pulling on a handle (not shown here) and by a tension force 16b acting on the holder 28 connected to the handle. The holder 28 is thus displaced within the slide cap 26 such that the vertical surfaces 30a and 30b come to rest on one another. The slide cap 26 is in turn movably supported in the guide rails not shown here and is dimensioned such that it can be moved in the situation shown in FIG. 3 without major friction with the guide rail along the closing direction 12. The reset force 16a of the shade and of the pretensioned take-up roller 13a (direction shown here in turn as an arrow) counteracts the tension force 16b by the operator.

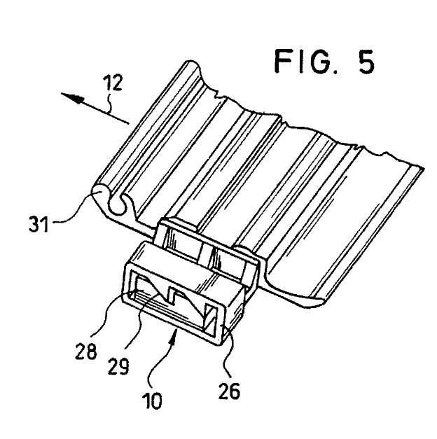

In FIG. 4, the slider from FIG. 3 is shifted to the right; this means that a shade 13 connected to the holder 28 is moved to the right by the reset force 16a of the shade. Thus the shade 13, after the operator has released it, is rolled up by the pretensioning of the take-up roller 13a in order to clear the cargo space, for example, which it covered beforehand. The reset force 16a of the shade in this case causes the slide cap 26 to be shifted by a still existing residual friction with the guide rail relative to the holder 28 along one direction 24, by which the sloped flanks 29a and 29b of the holder 28 and slide cap 26 from FIG. 3 now lie directly on one another and form a common slide surface 29. Since this slide surface 29 lies obliquely to the reset force 16a of the shade 13 and to the identically aligned displacement path of the shade, upon each subsequent displacement the action of the reset force 16a on the holder 28 leads to transverse forces 32 between the holder and the slide cap 26. These transverse forces 32 act perpendicular to the reset force 16a of the shade and thus transversely to the displacement direction thereof. Since the slide cap 26 is molded from elastic material, these transverse forces 32 lead to the holder's 28 bending the slide cap 29 up along the transverse forces 32 roughly in the direction of the guide rail, by which the braking surfaces 15 of the slide cap are in turn caused to brake with the opposing surfaces (not shown here) of the guide rail.

Alternatively, the holder 28 can also be elastic and/or the slider can be shaped altogether symmetrically. Thus, a braking action on the two sides of the slider 10 is achieved. For these illustrated embodiments with the holder 28 and slide cap 26, it is thus ensured that the slider 10 is moved to the right by the reset force 16a of the shade when the shade is taken up, therefore when the operator releases the shade 13, but uncontrolled snapping back does not occur. Instead, braking and this damped motion of the shade 13 take place.

In FIG. 5, the slider 10 of FIGS. 3 & 4 is again shown in a perspective view, in addition to the holder 28 and the slide cap 26 also the pull 31 of the shade being shown. The pull is connected on the one hand to the holder 28 and on the other to the free end of the shade, Thus, the operator can move the pull 31 in the closing direction 12 and thus unroll the shade, by which, for example, a cargo space can be covered. Since in this motion, as in all embodiments of the invention, the friction between the slider 10 and guide rails is at a minimum, withdrawal takes place with a low expenditure of force. On the other hand, after releasing the pull 31 or a handle connected to it by the above described interaction of the reset force 16a of the shade, on the one hand, and the opposite braking action by the slider 10, on the other hand, controlled, damped sliding of the pull 31 opposite the closing direction 12 is ensured.

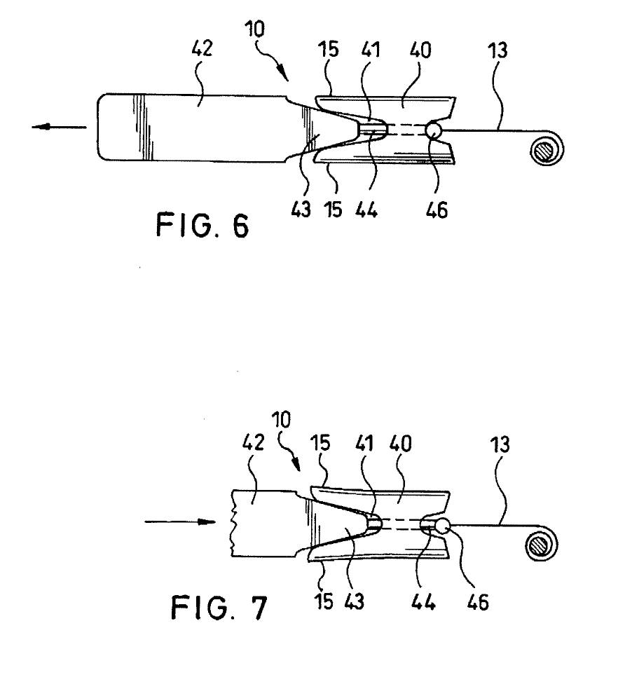

FIGS. 6 & 7 show an alternative embodiment of the invention, in which a slider 10 consists of a slide body 42 and a brake body 40. Both parts are movably interconnected by means of a driver 44 such that the slide body 40 can be moved along the common axis away from the brake body 42 to the left until it entrains the brake body by means of the stop 46 of the driver. This sequence of motion takes place when the operator unrolls the shade 13 by his moving the slider on the handle (not shown here) which is connected to the slider 10, to the left as shown in FIG. 6. The shade 13 is attached to the slide body 42 by means of the driver 44 and is likewise entrained by the slide body.

When the shade 13 is released to be taken up, the shade pulls the slider 10 to the right as shown in FIG. 7. In this connection the reset force of the shade 13 pulls a wedge-shaped extension 43 of the slide body 42 into a notch 41 of the brake body 40 so that the brake body is elastically spread apart. The braking surfaces 15 brake with the guide rail (not shown here) by the spreading apart in order to prevent the shade 13 from snapping back uncontrolled.

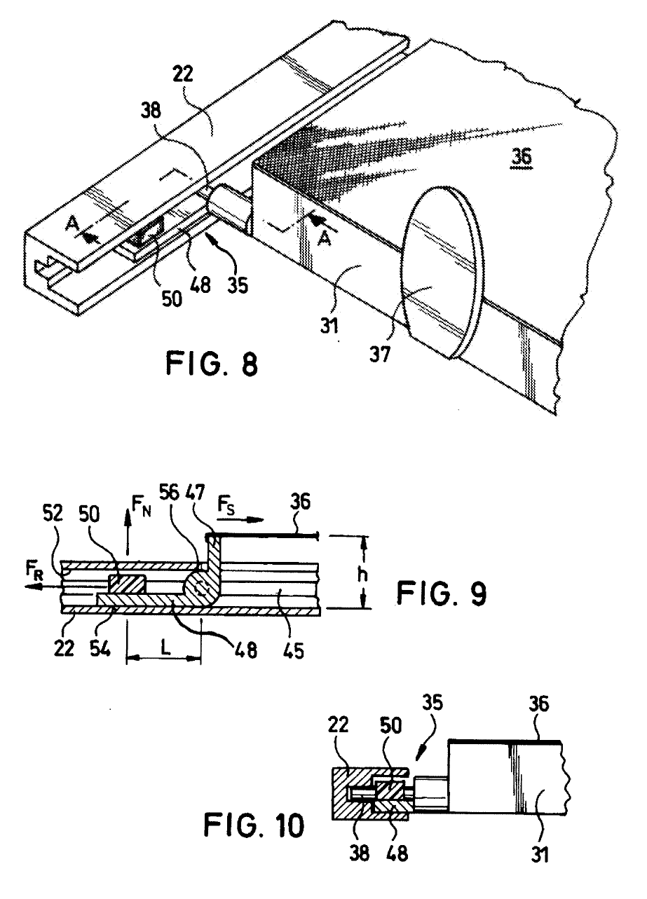

FIGS. 8 to 10 show another alternative embodiment of the shade system in accordance with the invention, FIG. 8 showing the shade system. In particular FIG. 8 shows in a perspective view a shade system in which the pull 31 is guided via lateral sliders 35 in a guide rail 22 which is located laterally to the roof opening. FIG. 9 shows a lengthwise section by the line A-A shown in FIG. 8, FIG. 10 shows a cross section. As is especially apparent from the sections, in the guide rail 22 there is a guideway 45 in which the slide pin 38 of the slider labeled 35 overall is supported. The slider 35 together with the pull bow 31 which is lengthened to the top beyond the guide rail 22 forms a lever element with a first lever arm 48 which points forward in the withdrawal direction of the shade and a second lever arm 47 which points up, with the shade length of shade 36 attached to its upper end.

The front lever arm 48 of the slider 35 bears a brake element 50 which engages an opposing surface 52 of the guide rail 22 when the pull 31 is tilted. In this connection FIG. 9 shows the state of the shade system when an operator pulls the shade forward by actuating a handle 37 which is provided on the pull (31) (FIG. 8) in order to unwind the length of shade 36, in this connection the pull and thus the slider 35 being tilted forward against the reset force F_{S} of the take-up roller (counterclockwise in FIG. 9). When the handle 37 is released, the slider 35 is tilted to the rear by the reset force F_{S} so that the brake element 50 rests against the guide rail 22. The braking or friction force F_{R} produced by the braking surface is computed in this connection from the coefficient of friction u which depends on the material and the normal force F_{N} acting vertically on the opposing surface 52:
F_{R}=μ·F_{N}.

In this connection the normal force F_{N} can be computed in turn based on the lever principle from the reset force of the shade F_{S}. In this connection the following applies to a slider with a lever arm 48 of length L which points forward in the withdrawal direction of the shade and a lever arm 47 of height h pointing up:
F_{N}·L=F_{S}·h
and

For the force of friction produced by the braking surface thus the following applies:
F_{R}=μ·h/L·F_{S}

Thus, with consideration of the coefficient of friction of the braking surface with reference to the material of the opposing surface of the guide rail the desired braking force can be easily set by a suitable geometrical configuration of the slider and the pull. In particular, the arrangement in this connection can be such that either provision is made for the pull's sliding back gently, as soon as the shade is released from the position which completely closes the roof opening, or the shade can be moved into any intermediate positions between the completely opened and completely closed position.

In the embodiments in which by means of the braking surface provision is to be made for the shade's gently sliding back into its completely taken-up position, by choosing the lever ratio with consideration of the coefficient of friction the opening or take-up speed of the shade can be established. If conversely the shade is to be able to be located in any intermediate positions between the completely opened and completely closed position, the corresponding configuration can provide for the friction force F_{R} being larger than the reset force Fs of the take-up roller, so that the shade remains in any position based on the reset force of the take-up roller. When the shade is to be opened, i.e. to be taken up on the take-up roller, the pull is tilted forward and the shade is pushed to the rear by hand. For the configuration of the slider 35 which is shown in FIGS. 9 and 10 and in which the slider is supported via the slide pin 38 in the guideway 45 of the guide rail 22, the slide surface of the slider and the braking surface of the slider run in different guideways of the guide rail 22.? Slide windings inserted in the area of the slide pin 38 thus do not adversely affect the braking action of the slide surface. It goes without saying that the slide surfaces and the braking surfaces could also be located completely separately from one another, for example, by the slider 35 being made such that the brake element 50 acts from the outside against the guide rail 22. In particular, when holding of the shade in intermediate positions is not to be done, and the braking surfaces are to be used for the shade to slide gently back, however a separate guide channel 45 and slide pin 38 can be omitted, and the slider 35 could then be made such that it is guided with its bottom 54 of the lever arm 48 and with the top 56 of its central area acting on the pull 31 within the guide rail 22.

What is claimed is:

1. Vehicle shade system, comprising:
a take-up roller,
a shade which is extendable against a reset force of the take-up roller,
a guide rail which runs parallel to a closing direction of the shade at each side thereof, and
at least one pull, the pull having a handle for actuating the shade and at least one slider at each of opposite lateral sides which is movably supported in the guide rail and which has at least one braking surface,
wherein the slider is adapted to have the braking surface thereof shifted toward the guide rail by a reset force exerted by the take-up roller when the handle is released, by which the braking surface brakes against at least one opposing surface of the guide rail.

2. Shade system in accordance with claim 1, wherein at least one braking surface of the slider is a separately attached element with a high coefficient of friction.

3. Shade system in accordance with claim 1, wherein the slider has several braking surfaces which brake against at least two opposing surfaces of the guide rail which are located on opposing sides of the slider.

4. Shade system in accordance with claim 1, wherein the reset force is greater than the braking action of the at least one slider.

5. Shade system in accordance with claim 1, wherein the shade system is designed such that by pulling on the handle in a closing direction, the tension force applied in doing so counteracting the reset force of the shade, at least one braking surface is shifted away from the guide rail, by which the braking action is reduced.

6. Shade system in accordance with claim 1, wherein the slider has an axis of rotation perpendicular to the closing direction of the shade, around which a torque acts by the reset force of the shade, by which, when the shade is released to be taken up, the braking surface is pressed against the opposing surface of the guide rail and brakes with it.

7. Shade system in accordance with claim 6, wherein the axis of rotation of the slider is parallel to the take-up roller onto which the shade can be taken up.

8. Shade system in accordance with claim 6, wherein the slider has at least two braking surfaces which are located diametrically to the axis of rotation.

9. Shade system in accordance with claim 6, wherein the shade system is designed such that by pulling on the handle in the closing direction, a torque acts on the slider which counteracts the torque produced by the reset force of the shade.

10. Shade system in accordance with claim 1, wherein the braking surface is formed at least in part by the slide surface of the slider guided in the guide rail.

11. Shade system in accordance with claim 1, wherein the guide rail has a guideway in which the slider is movably guided, and the opposing surface of the guide rail with which the braking surface brakes is located outside of the guideway.

12. Shade system in accordance with claim 1, wherein the slider has a holder and a slide cap, the holder being connected to the shade and the slide cap being movably supported on the holder parallel to the withdrawal direction of the shade and the slide cap on at least one side which is assigned to the guide rail having at least one braking surface, when the shade is released for take-up, the holder and the slide cap being displaced against one another by the reset force of the shade transversely to the displacement direction of the shade along at least one common slide surface, and in this way, the braking surface being pressed against the opposing surface of the guide rail and braking with it.

13. Shade system in accordance with claim 12, wherein at least one common slide surface is formed from at least one sloped flank of the holder and at least one sloped flank of the slide cap and comprises essentially flat individual surfaces which form an angle between 10° and 80° with the displacement direction of the shade.

14. Shade system in accordance with claim 13, wherein at least one common slide surface forms an angle between 30° and 60° with the displacement direction of the shade.

15. Shade system in accordance with claim 13, wherein the sloped flanks of the holder are oriented in the direction of the take-up roller and the sloped flanks of the slide cap are oriented in the withdrawal direction of the shade.

16. Shade system in accordance with claim 13, wherein the holder and the slide cap have a sawtooth-like surface along the displacement direction of the shade, the teeth of the holder and slide cap each being formed by essentially vertical flanks and by sloped flanks.

17. Shade system in accordance with claim 12, wherein the holder is inserted into the slide cap and when the holder and the slide cap are displaced relative one another, the holder elastically deforms the slide cap to the outside at an angle relative to the displacement direction, so that the braking surface of the slider which is mounted on the slide cap brakes with the guide rail.

18. Shade system in accordance with claim 12, wherein the handle is connected to the slide cap.

19. Shade system in accordance with claim 1, wherein the slider comprises a slide body which is connected to the shade, and of a separate brake body which is located between the slide body and shade, the brake body bearing at least one braking surface and the slide body having a wedge-shaped extension which points in the direction of the brake body, and the brake body having a notch which the extension hits when the shade is rolled up, by which the brake body is spread elastically and at least one braking surface brakes with the guide rail.

20. Shade system in accordance with claim 19, wherein the slide body and brake body are connected to one another via a driver such that the brake body is allowed to move as far as the stop of the driver, parallel to the direction of motion of the slider away from the slide body.
